(19) United States
(12) Patent Application Publication
(10) Pub. No.: US 2012/0112600 A1
(43) Pub. Date: May 10, 2012

(54) STATOR FOR ELECTRIC ROTATING MACHINE

(75) Inventors: Keiji KONDOU, Toyota-shi (JP); Makoto TANIGUCHI, Obu-shi (JP); Takeo MAEKAWA, Okazaki-shi (JP)

(73) Assignee: DENSO CORPORATION, Kariya-city (JP)

(21) Appl. No.: 13/287,330

(22) Filed: Nov. 2, 2011

(30) Foreign Application Priority Data
Nov. 5, 2010 (JP) 2010-248612
Jul. 20, 2011 (JP) 2011-159267

(51) Int. Cl. H02K 1/18

(52) U.S. Cl. 310/216.086

(57) ABSTRACT

A stator includes a stator core and a multi-phase stator coil distributedly wound on the stator core. The stator core includes a plurality of teeth and a yoke having a plurality of grooves. Each of the teeth has a press-fit portion, which is press-fitted in a corresponding one of the grooves of the yoke, and a main body portion extending from the press-fit portion in a direction away from the corresponding groove. The press-fit portion has a pair of contact surfaces which are both in contact with a bottom surface of the corresponding groove and away from each other in a width direction of the tooth. Further, (a+b)≦e/2, where a and b respectively represent widths of the contact surfaces of the press-fit portion, and e represents a width of the main body portion at a press-fit portion-side end of the main body portion.

### CROSS-REFERENCE TO RELATED APPLICATIONS

This application is based on and claims priority from Japanese Patent Applications No. 2010-248612 filed on Nov. 5, 2010 and No. 2011-159267 filed on Jul. 20, 2011, the contents of which are hereby incorporated by reference in their entireties into this application.

### BACKGROUND OF THE INVENTION

1. Technical Field of the Invention

The present invention relates to stators for electric rotating machines that are used in, for example, motor vehicles as electric motors and electric generators. In addition, the invention can also be applied to industrial machines and household electrical appliances.

2. Description of the Related Art

A conventional stator core 100 for an electric rotating machine includes, as shown in FIG. 11A, a plurality of teeth 102 and a yoke (or magnetic flux path yoke) 103. Each of the teeth 102 has its distal end facing a rotor 101. The yoke 103 is separately formed from the teeth 102 and magnetically connects the proximal ends of the teeth 102 on the opposite side to the rotor 101.

The stator core 100 is formed by press-fitting each of the teeth 102 into a corresponding one of grooves 104 that are formed in a radially inner surface of the yoke 103 (see, for example, Japanese Patent Application Publication No. 2005-73490).

Further, when a multi-phase stator coil (not shown) is wound around the teeth 102 using a concentrated winding method, for each of the teeth 102, the load of a corresponding part of the stator coil which is wound around the tooth 102 is supported only by the tooth 102 itself.

More specifically, for each of the teeth 102, the load of the corresponding part of the stator coil is imposed on a joint portion 107 between the tooth 102 and the yoke 103. Consequently, when an external force is applied to the electric rotating machine and thereby causes the stator coil to vibrate, the tooth-holding force of the joint portion 107 (or the force of the yoke 103 holding the tooth 102) may be insufficient to withstand the vibration of the stator coil. As a result, the stator tooth 102 may be detached from the yoke 103.

On the other hand, as shown in FIG. 11B, to lower the press-fitting load for press-fitting the teeth 102 into the corresponding grooves 104 of the yoke 103, for each of the teeth 102, there are formed recesses 109 in a contact surface 108 of the yoke 103 (i.e., the bottom surface of the corresponding groove 104) which makes contact with the tooth 102. Consequently, the contact area between the tooth 102 and the yoke 103 is reduced, thereby lowering the tooth-holding force of the joint portion 107.

Moreover, to increase the tooth-holding force of the joint portion 107, one may consider increasing the press-fitting interference in press-fitting the teeth 102 into the corresponding grooves 104 of the yoke 103. However, with increase in the press-fitting interference, the residual compressive stress around the joint portion 107 will also be increased, thereby resulting in an increase in the iron loss of the stator core 100.

That is, there is a contradiction that: a reduction in the press-fitting load may cause the tooth-holding force of the joint portion 107 to be lowered; and an increase in the tooth-holding force of the joint portion 107 may cause the residual compressive stress around the joining potion 107 to be increased.

### SUMMARY

According to an embodiment, there is provided a stator for an electric rotating machine. The stator includes a stator core and a multi-phase stator coil distributedly wound on the stator core. The stator core includes a plurality of teeth and a yoke that is separately formed from the teeth and magnetically connects the teeth. The yoke has a plurality of grooves formed in a surface thereof Each of the teeth has a press-fit portion, which is press-fitted in a corresponding one of the grooves of the yoke, and a main body portion that extends from the press-fit portion in a direction away from the corresponding groove. The press-fit portion has a pair of contact surfaces which are both in contact with a bottom surface of the corresponding groove of the yoke and away from each other in a width direction of the tooth. Moreover, the following dimensional relationship is satisfied: (a+b)≦e/2, where a and b respectively represent widths of the contact surfaces of the press-fit portion, and e represents a width of the main body portion at a press-fit portion-side end of the main body portion.

With the above configuration, it is possible to secure a sufficient tooth-holding force of each of the joint portions between the teeth and the yoke. Moreover, it is also possible to lower the press-fitting load for press-fitting the press-fit portion 22s of the teeth into the corresponding grooves of the yoke. Furthermore, it is also possible to reduce the residual compressive stress around each of the joint portions, thereby minimizing the iron loss of the stator core.

According to further implementations, the following dimensional relationship is further specified: a=b.

For each of the teeth of the stator core, the following dimensional relationship is further specified: 0.8≦d/e≦1.2, where d represents a width of the press-fit portion at its end facing the bottom surface of the corresponding groove of the yoke.

For each of the teeth of the stator core, the contact surfaces are first contact surfaces of the press-fit portion. The press-fit portion also has a pair of second contact surfaces which are respectively in contact with an opposite pair of side surfaces of the corresponding groove of the yoke. Moreover, the following dimensional relationship is further specified: 0°<α<45°, where a represents an angle between each of the second contact surfaces and a centerline of the tooth, the centerline being an imaginary line which bisects the tooth in the width direction thereof.

Each of the grooves of the yoke has a neck part in the vicinity of an open end of the groove which opens on the surface of the yoke. For each of the teeth of the stator core, the press-fit portion of the tooth has a neck part that is press-fitted to the neck part of the corresponding groove of the yoke. Moreover, for each of the teeth of the stator core, the following dimensional relationship is further specified: W1<W2, where W1 represents a width of the main body portion at its end on the opposite side to the press-fit portion, and W2 represents a width of the press-fit portion at its neck part.

Furthermore, in the stator core, the following dimensional relationship is further specified: β11≦β2/2, where β1 represents a depth of each of the grooves of the yoke, and β2 is a radial thickness of the yoke.

### BRIEF DESCRIPTION OF THE DRAWINGS

The present invention will be understood more fully from the detailed description given hereinafter and from the accompanying drawings of one preferred embodiment, which, however, should not be taken to limit the invention to the specific embodiment but are for the purpose of explanation and understanding only.

In the accompanying drawings:

FIG. 1 is a partially cross-sectional schematic view illustrating the overall configuration of an electric rotating machine which includes a stator according an embodiment;

FIG. 2 is a plan view of a stator core of the stator;

FIG. 3 is a schematic view illustrating a method of winding a stator coil of the stator on the stator core;

FIG. 4A is an enlarged view of part of the stator core;

FIG. 4B is an enlarged view showing a joint portion between a tooth and a yoke of the stator core;

FIG. 5 is a graphical representation illustrating the relationship between the iron loss of the stator core and the residual compressive stress around the joint portion;

FIG. 6 is a graphical representation illustrating both the relationship between the relative tooth-holding force of the joint portion and a dimensional parameter (a+b) and the relationship between the relative efficiency of the electric rotating machine and the dimensional parameter (a+b);

FIG. 7 is a graphical representation illustrating both the relationship between the weight of the tooth and a dimensional parameter d/e and the relationship between the amount of magnetic flux flowing through the tooth and the dimensional parameter d/e;

FIG. 8 is a schematic view illustrating the influence of the dimensional accuracy of a press-fit portion 22 of the tooth on the press-fitting interference in press-fitting the press-fit portion 22 into a groove of the yoke;

FIG. 9 is a graphical representation illustrating the relationship between α and g/δ, where α is an angle between each second contact surface of the press-fit portion and a centerline X of the tooth, g is the press-fitting interference, and δ is a radially inward error produced in machining the press-fit portion 22;

FIG. 10 is a graphical representation illustrating both the relationship between the relative tooth-holding force of the joint portion and a dimensional parameter ⊕1≦β2 and the relationship between the relative torque of the electric rotating machine and the dimensional parameter ⊕1≦β2;

FIG. 11A is a cross-sectional schematic view illustrating the configuration of a conventional stator core; and

FIG. 11B is an enlarged view of part of FIG. 11A.

### DESCRIPTION OF PREFERRED EMBODIMENT

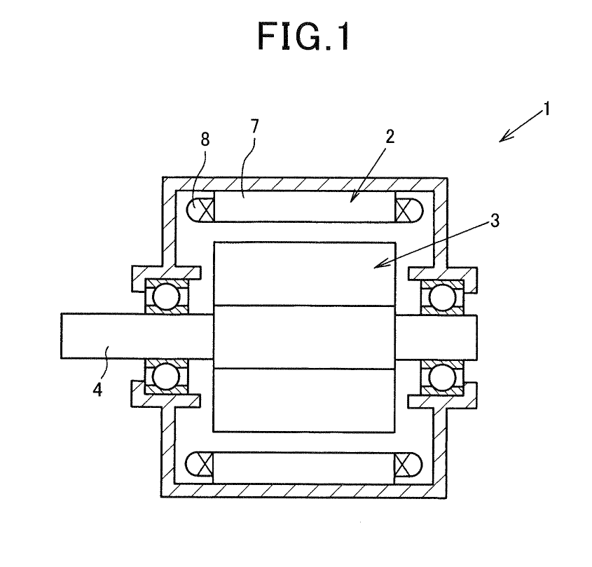

FIG. 1 shows the overall configuration of an electric rotating machine 1 which includes a stator 2 according to an embodiment. In this embodiment, the electric rotating machine 1 is configured as a three-phase AC motor.

As shown in FIG. 1, the electric rotating machine 1 includes the stator 2 that creates a rotating magnetic field, a rotor 3 that is disposed radially inside of the stator 2 and rotated by the rotating magnetic field created by the stator 2, and a rotating shaft 4 which rotates together with the rotor 3 and through which torque generated by the electric rotating machine 1 is output.

The stator 2 includes a stator core 7 and a three-phase stator coil 8 wound on the stator core 7. In operation, upon supplying three-phase AC power to the stator coil 8, the stator 2 creates the rotating magnetic field, which causes the rotor 3 to rotate. In addition, in the present embodiment, the rotor 3 is of a SPM (Surface Permanent Magnet) type. However, it should be noted that the rotor 3 may also be of other types, such as an IPM (Interior Permanent Magnet) type, an electromagnet type and an iron core type.

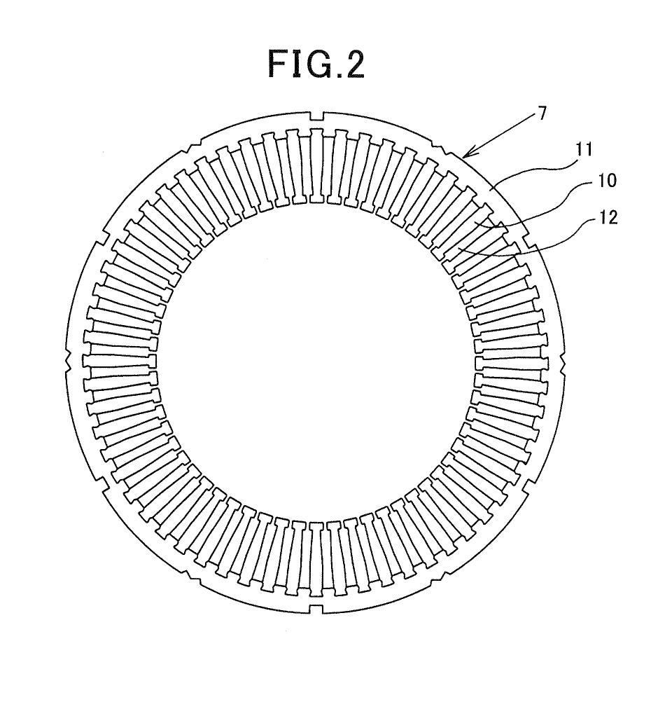

The stator core 7 is formed of a plurality of magnetic steel sheets and has a hollow cylindrical shape. As shown in FIG. 2, the stator core 7 includes a plurality of teeth 10 and a yoke (or magnetic flux path yoke) 11. Each of the teeth 10 has its distal end facing the rotor 3. The yoke 11 is separately formed from the teeth 10 and magnetically connects the proximal ends of the teeth 10 on the opposite side to the rotor 3 (or on the radially outside of the teeth 10).

The yoke 11 has an annular shape. On the radially inner side of the yoke 11, the teeth 10 are assembled to the yoke 11 so as to be arranged in the circumferential direction of the yoke 11 at predetermined intervals. Between each circumferentially-adjacent pair of the teeth 10, there is formed a slot 12.

The stator coil 8 is comprised of U-phase, V-phase and W-phase windings and distributedly wound (or wound using a distributed winding method) on the stator core 7.

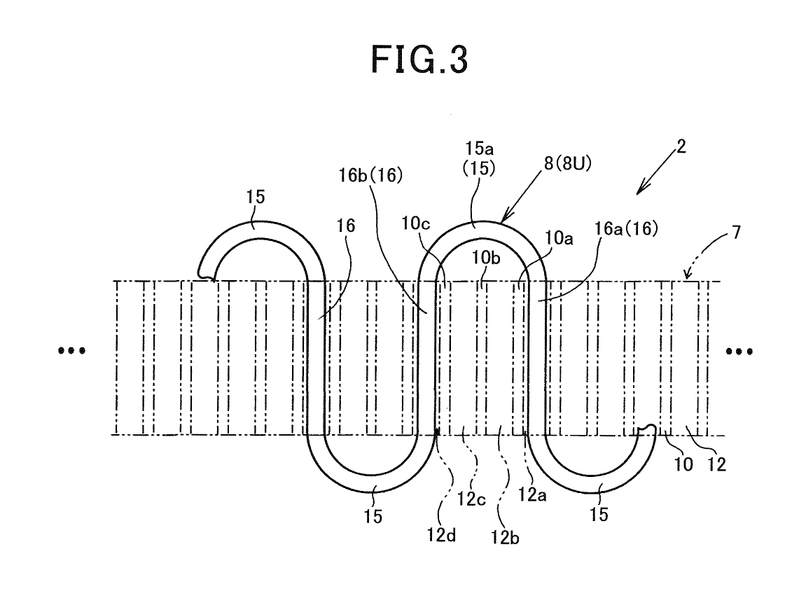

FIG. 3 illustrates, taking the U-phase winding 8U as an example, the method of distributedly winding the stator coil 8 on the stator core 7.

In the present embodiment, the U-phase winding 8U is formed of an electric wire bundle which includes a plurality of insulation-coated electric wires. The U-phase winding 8U is bent into a wave shape to include a plurality of turn portions 15 and a plurality of in-slot portions 16. Each of the in-slot portions 16 is received in a corresponding one of the slots 12 of the stator core 7. Each of the turn portions 15 protrudes from a corresponding one of axial end faces of the stator core 7 to connect a corresponding adjacent pair of the in-slot portions 16. Consequently, the turn portions 15 are alternately located on opposite axial sides of the stator core 7 in the circumferential direction of the stator core 7.

For example, as shown in FIG. 3, the U-phase winding 8U has the in-slot portion 16a received in the slot 12a of the stator core 7, the in-slot portion 16b received in the slot 12d of the stator core 7, and the turn portion 15a extending across the slots 12b and 12c of the stator core 7 to connect the in-slot portions 16a and 16b. In other words, the turn portion 15a extends across the three teeth 10a-10c of the stator core 7 which are positioned between the slots 12a and 12d.

In addition, it should be noted that the V-phase and W-phase windings of the stator coil 8 are formed and wound on the stator core 7 in the same manner as the U-phase winding.

Consequently, in the present embodiment, each of the U-phase, V-phase and W-phase windings of the stator coil 8 is not concentratedly wound on only one of the teeth 10 of the stator core 7, but distributedly wound on a predetermined number of the teeth 10.

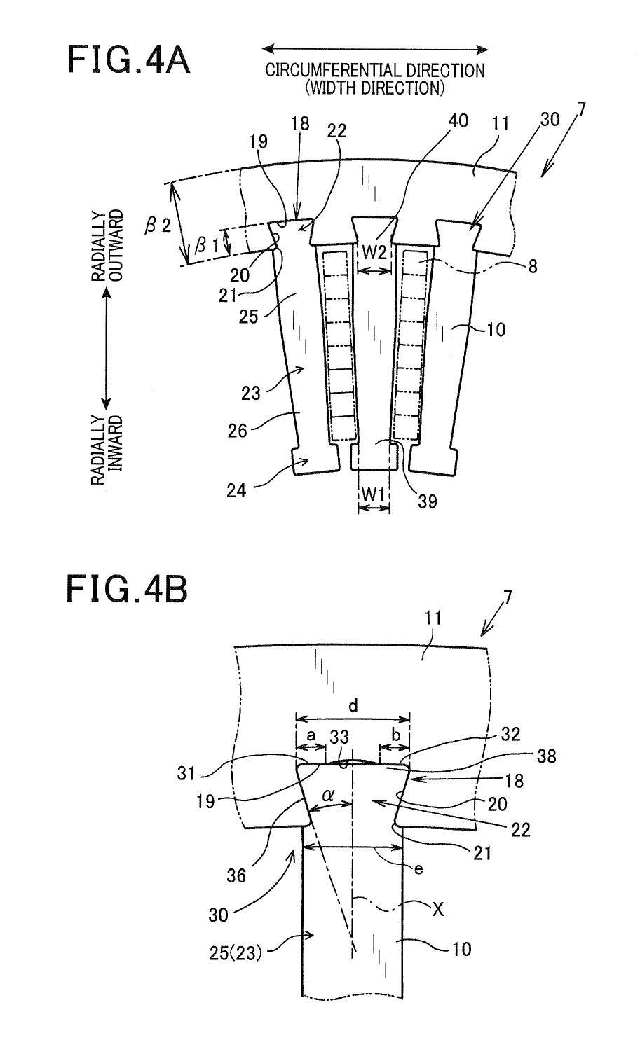

Next, the detailed configuration of the teeth 10 and yoke 11 of the stator core 7 will be described with reference to FIGS. 4A and 4B.

In the present embodiment, the yoke 11 has a plurality of grooves 18 that are formed in the radially inner surface of the yoke 11 so as to be spaced from one another in the circumferential direction of the yoke 11 at predetermined intervals. In each of the grooves 18, there is press-fitted a corresponding one of the teeth 10.

Each of the grooves 18 opens at its radially inner end on the radially inner surface of the yoke 11 and has a bottom surface 19 at its radially outer end. Further, each of the grooves 18 tapers radially inward, so that the circumferential width (i.e., the width in the circumferential direction of the yoke 11) of each of the grooves 18 is gradually decreased in the radially inward direction. Moreover, each of the grooves 18 has a neck part (or constricted part) 21 in the vicinity of the open end (i.e., the radially inner end) of the groove 18; the neck part 21 has a circumferential width that is slightly smaller than the circumferential width of the open end.

Each of the teeth 10 makes up one magnetic salient pole of the stator core 7. Each of the teeth 10 has a press-fit portion 22, a main body portion 23 and a distal end portion (or radially inner end portion) 24. The press-fit portion 22 is press-fitted into the corresponding groove 18 of the yoke 11. The main body portion 23 extends from the press-fit portion 22 radially inward. The distal end portion 24 is positioned furthest from the corresponding groove 18 and has a circumferential width that is greater than the circumferential width of the main body portion 23 at the boundary between the main body portion 23 and the distal end portion 24.

More specifically, as shown in FIG. 4B, the press-fit portion 22 has a shape that matches with the shape of the corresponding groove 18. Further, the press-fit portion 22 is reduced in the circumferential width to have a neck part (constricted part) 40 that is press-fitted to the neck part 21 of the corresponding groove 18. In addition, the circumferential width of the press-fit portion 22 is increased from the neck part 40 to the boundary between the press-fit portion 22 and the main body portion 23.

The main body portion 23 includes, as shown in FIG. 4A, a straight part 25 and a tapering part 26. The straight part 25 extends from the press-fit portion 22 radially inward keeping its circumferential width constant. The tapering part 26 tapers from the straight part 25 radially inward so that the circumferential width of the tapering part 26 is gradually decreased in the radially inward direction.

Each of the teeth 10 is fixed to the yoke 11 by press-fitting the press-fit portion 22 of the tooth 10 into the corresponding groove 18 of the yoke 11. In addition, that part of the stator core 7 where the press-fit portion 22 of the tooth 10 is press-fitted in the corresponding groove 18 of the yoke 11 will be referred to as a joint portion 30 between the tooth 10 and the yoke 11 hereinafter.

Moreover, for each of the teeth 10, the radially outer end surface of the press-fit portion 22 of the tooth 10 includes an opposite pair of end parts which are both in contact with the bottom surface 19 of the corresponding groove 18 of the yoke 11 and away from each other in the width direction of the tooth 10 (or in the circumferential direction of the yoke 11). The end parts of the radially outer surface of the press-fit portion 22 respectively make up a pair of first contact surfaces 31 and 32 of the press-fit portion 22.

More specifically, in a circumferentially central part of the bottom surface 19 of the corresponding groove 18, there is formed a recess 33 so as to be recessed radially outward. The first contact surfaces 31 and 32 respectively abut (or make contact with) those two parts of the bottom surface 19 of the corresponding groove 18 which are respectively on opposite sides of the recess 33 in the circumferential direction of the yoke 11.

In addition, the recess 33 is provided for reducing the contact area between the press-fit portion 22 of the tooth 10 and the bottom surface 19 of the corresponding groove 18 of the yoke 11 and thereby lowering the press-fitting load for press-fitting the press-fit portion 22 into the corresponding groove 18.

Furthermore, the press-fit portion 22 also has an opposite pair of circumferential end surfaces which are respectively in contact with an opposite pair of side surfaces 20 of the corresponding groove 18. The circumferential end surfaces make up second contact surfaces 36 of the press-fit portion 22.

In addition, each of the second contact surfaces 36 extends obliquely with respect to a centerline X of the tooth 10, with a predetermined angle α formed between the second contact surface 36 and the centerline X. Here, the centerline X is an imaginary line which bisects the tooth 10 in the width direction of the tooth 10 (or in the circumferential direction of the yoke 11).

Moreover, in the present embodiment, referring to FIGS. 4A and 4B, for each of the teeth 10, the following dimensional relationships (1)-(5) are specified.

(a+b)≦e/2, (1)

where a and b respectively represent the widths of the pair of first contact surfaces 31 and 32 of the press-fit portion 22, and e represents the width of the main body portion 23 at the press-fit portion 22-side end thereof (i.e., the width of the straight part 25 of the main body portion 23).

0.8≦d/e≦1.2, (2)

where d represents the width of the press-fit portion 22 at its radially outer end 38 (i.e., its end facing the bottom surface 19 of the corresponding groove 18).

0°<α<45°, (3)

where α represents the predetermined angle between each of the second contact surfaces 36 of the press-fit portion 22 and the centerline X of the tooth 10.

W1<W2, (4)

where W1 represents the width of the tapering part 26 of the main body portion 23 at its radially inner end 39 (i.e., its end on the opposite side to the press-fit portion 22), and W2 represents the width of the press-fit portion 22 at its neck part 40 which is press-fitted to the neck part 21 of the corresponding groove 18.

β1≦β2/2 (5)

where β1 represents the depth of the corresponding groove 18, and β2 is the radial thickness of the yoke 11.

In addition, in the present embodiment, for each of the teeth 10, the width direction of the tooth 10 is perpendicular to both the centerline X of the tooth 10 and the axial direction of the yoke 11. Moreover, the widths of the pair of first contact surfaces 31 and 32 of the press-fit portion 22 are equal to each other (i.e., a=b).

The above-described stator 2 according to the present embodiment has the following advantages.

In the present embodiment, the stator coil 8 is wound on the stator core 7 using the distributed winding method as described above.

Consequently, unlike in the case of using a concentrated winding method, the load of each of the U-phase, V-phase and W-phase windings of the stator coil 8 is not concentrated on only one of the teeth 10 of the stator core 7, but distributed to a predetermined number of the teeth 10.

Therefore, compared to the case of using a concentrated winding method, the load imposed on each of the joint portions 30 between the teeth 10 and the yoke 11 is lowered.

Further, when an external force is applied to the electric rotating machine 1 to cause the stator coil 8 to vibrate, the mechanical shock induced by the vibration of each of the U-phase, V-phase and W-phase windings of the stator coil 8 will also be distributed to the predetermined number of the teeth 10.

Therefore, it is unnecessary for each of the joint portions 30 to have a large tooth-holding force. Accordingly, it is unnecessary to increase the press-fitting interference in press-fitting the teeth 10 into the corresponding grooves 18 of the yoke 11, for the purpose of securing a high tooth-holding force of each of the joint portions 30. In other words, it is possible to obtain a sufficient tooth-holding force of each of the joint portions 30 even with a small press-fitting interference in press-fitting the teeth 10 into the corresponding grooves 18.

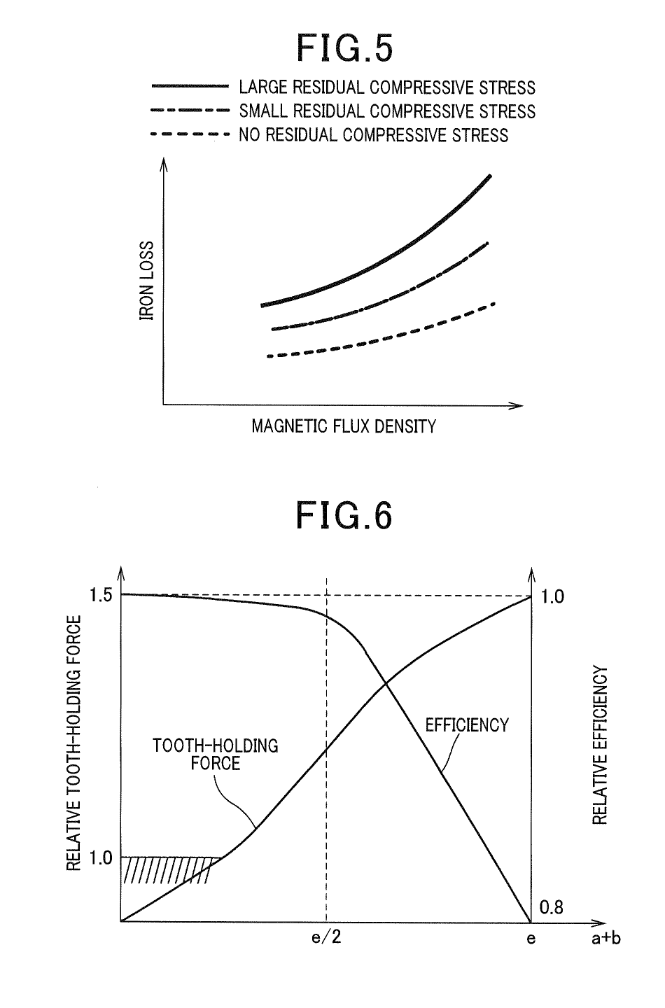

In addition, the residual compressive stress around each of the joint portions 30 increases with the press-fitting interference in press-fitting the teeth 10 into the corresponding grooves 18 of the yoke 11. Further, as shown in FIG. 5, at the same magnetic flux density, the iron loss of the stator core 7 increases with the residual compressive stress around each of the joint portions 30.

More specifically, in FIG. 5, the dashed line indicates the change in the iron loss of the stator core 7 with the magnetic flux density in the case of the residual compressive stress being zero; the one-dot chain line indicates the same in the case of the residual compressive stress being small; and the solid line indicates the same in the case of the residual compressive stress being large.

As seen from FIG. 5, at the same magnetic flux density, the iron loss of the stator core 7 in the case of the residual compressive stress being small is greater than that in the case of the residual compressive stress being zero. Further, the iron loss of the stator core 7 in the case of the residual compressive stress being large is greater than that in the case of the residual compressive stress being small.

Therefore, since the press-fitting interference in press-fitting the teeth 10 into the corresponding grooves 18 of the yoke 11 can be set small in the present embodiment, it is possible to lower the residual compressive stress around each of the joint portions 30, thereby reducing the iron loss of the stator core 7.

Moreover, in the present embodiment, the dimensional relationship of (a+b)≦e/2 is specified.

Specifying the above dimensional relationship, it is possible to secure a high efficiency of the electric rotating machine 1 while securing a sufficient tooth-holding force of each of the joint portions 30.

Specifically, the press-fitting load for press-fitting the teeth 10 into the corresponding grooves 18 of the yoke 11 increases with (a+b).

Therefore, to suppress the press-fitting load below an upper limit, above which a press-fitting device for press-fitting the teeth 10 into the corresponding grooves 18 of the yoke 11 may be damaged, it is necessary to set (a+b) to be less than or equal to e/2.

In other words, satisfying the dimensional relationship of (a+b)≦e/2, it is possible to make the press-fitting load lower than the upper limit above which the press-fitting device may be damaged.

Further, by suppressing the press-fitting load, it is possible to suppress the residual compressive stress around each of the joint portions 30. Consequently, it is possible to suppress the iron loss of the stator core 7, thereby preventing a decrease in the efficiency of the electric rotating machine 1.

FIG. 6 illustrates both the relationship between the relative tooth-holding force of each of the joint portions 30 and (a+b) and the relationship between the relative efficiency of the electric rotating machine 1 and (a+b). Here, the relative tooth-holding force is the ratio of the actual tooth-holding force to a required tooth-holding force; the relative efficiency is the ratio of the actual efficiency to a reference efficiency that is achieved without residual compressive stress around each of the joint portions 30.

As seen from FIG. 6, when (a+b)=e, the relative tooth-holding force is equal to 1.5. In other words, the tooth-holding force of each of the joint portions 30 is excessively large. In this case, it is necessary to employ a large-scale press-fitting device for press-fitting the teeth 10 into the corresponding grooves 18 of the yoke 11, thereby increasing the manufacturing cost.

On the other hand, the relative efficiency begins to rapidly drop as (a+b) increases to exceed e/2. Further, when (a+b) has increased to e, the relative efficiency becomes equal to 0.8. In other words, the efficiency of the electric rotating machine 1 is decreased by 20% in comparison with the reference efficiency. In addition, this decrease in the efficiency of the electric rotating machine 1 is caused by an increase in the residual compressive stress resulting from an increase in the contact surface area between the first contact surfaces 31 and 32 of the press-fit portions 22 of the teeth 10 and the bottom surfaces 19 of the corresponding grooves 18 of the yoke 11.

Accordingly, it is made clear from FIG. 6 that by specifying (a+b)≦e/2, it is possible to secure a high efficiency of the electric rotating machine 1 while securing a sufficient tooth-holding force of each of the joint portions 30.

In addition, the relative tooth-holding force is equal to 1 when (a+b) is approximately equal to 0.3. In other words, when (a+b) is approximately equal to 0.3, it is possible to secure the required tooth-holding force for each of the joint portions 30. Accordingly, to more reliably secure a sufficient tooth-holding force of each of the joint portions 30, it is further preferable that (a+b)≧0.3.

Moreover, in the present embodiment, the dimensional relationship of 0.8≦d/e≦1.2 is further specified.

Specifying the above dimensional relationship, it is possible to reduce the weight (or mass) of each of the teeth 10 and thereby secure a sufficient tooth-holding force of each of the joint portions 30 while securing a sufficient amount of magnetic flux flowing through each of the teeth 10 to keep high performance of the electric rotating machine 1.

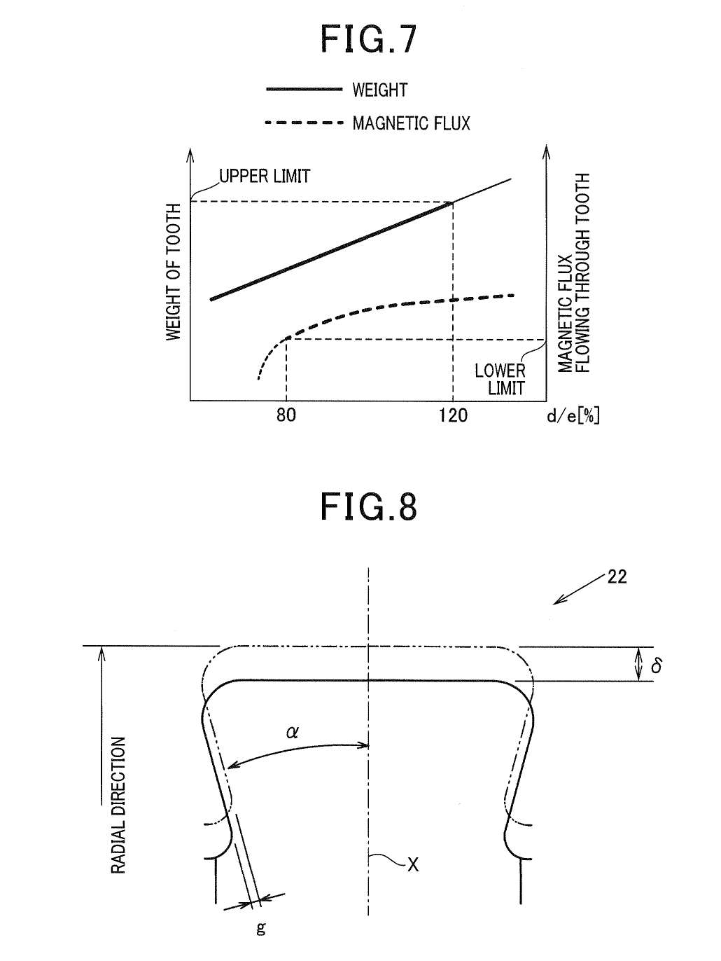

FIG. 7 illustrates both the relationship between the weight of each of the teeth 10 and the ratio d/e and the relationship between the amount of magnetic flux flowing through each of the teeth 10 and the ratio d/e.

As seen from FIG. 7, the weight of each of the teeth 10 increases with the ratio d/e. That is, for each of the teeth 10, as the width d of the press-fit portion 22 at its radially outer end 38 increases with the width e of the straight part 25 of the main body portion 23 kept constant, the weight of the tooth 10 also increases as indicated with a solid line in FIG. 7.

On the other hand, the amount of magnetic flux flowing through each of the teeth 10 decreases with the ratio d/e. That is, for each of the teeth 10, as the width d of the press-fit portion 22 at its radially outer end 38 decreases with the width e of the straight part 25 of the main body portion 23 kept constant, the amount of magnetic flux flowing through the tooth 10 also decreases as indicated with a dashed line in FIG. 7.

In terms of minimizing the required tooth-holding force of each of the joint portions 30, it is preferable to lower the ratio d/e and thereby reduce the weight of each of the teeth 10. In other words, reducing the weight of each of the teeth 10, it is easier to secure the required tooth-holding force of each of the joint portions 30. On the other hand, in terms of securing high performance of the electric rotating machine 1, it is preferable to raise the ratio d/e and thereby increase the amount of magnetic flux flowing through each of the teeth 10.

More specifically, as shown in FIG. 7, when the ratio d/e is higher than 120% (or 1.2), the weight of each of the teeth 10 is greater than an upper limit, above which it is difficult to secure the required tooth-holding force of each of the joint portions 30. On the other hand, when the ratio d/e is lower than 80% (or 0.8), the amount of magnetic flux flowing through each of the teeth 10 is less than a lower limit, below which it is difficult to secure high performance (e.g., high output torque) of the electric rotating machine 1.

Accordingly, it is made clear from FIG. 7 that by specifying 0.8≦d/e≦1.2, it is possible to secure a sufficient tooth-holding force of each of the joint portions 30 while keeping high performance of the electric rotating machine 1.

In the present embodiment, the dimensional relationship of 0°<α<45° is further specified.

Specifying the above dimensional relationship, it is possible to limit the influence of dimensional accuracy of the press-fit portions 22 of the teeth 10 on the press-fitting interference in pressing-fitting the press-fit portions 22 into the corresponding grooves 18 of the yoke 11.

Specifically, for each of the teeth 10, when there is, for example, a radial error δ produced in machining the press-fit portion 22, the press-fitting interference in the width direction of the corresponding groove 18 is accordingly changed.

For example, in FIG. 8, the dashed line indicates the desired shape of the press-fit portion 22. When there is a radially inward error 6 produced in machining the press-fit portion 22 due to variation in the machining accuracy, the width of the pressing-fitting portion 22 is increased, thereby increasing the press-fitting interference by g.

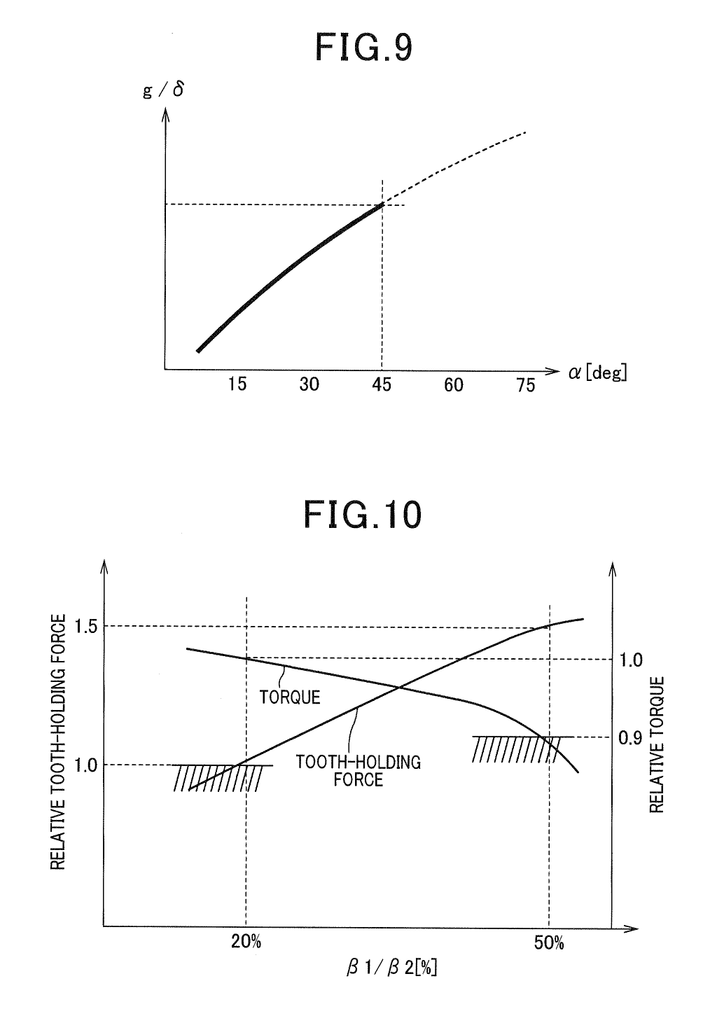

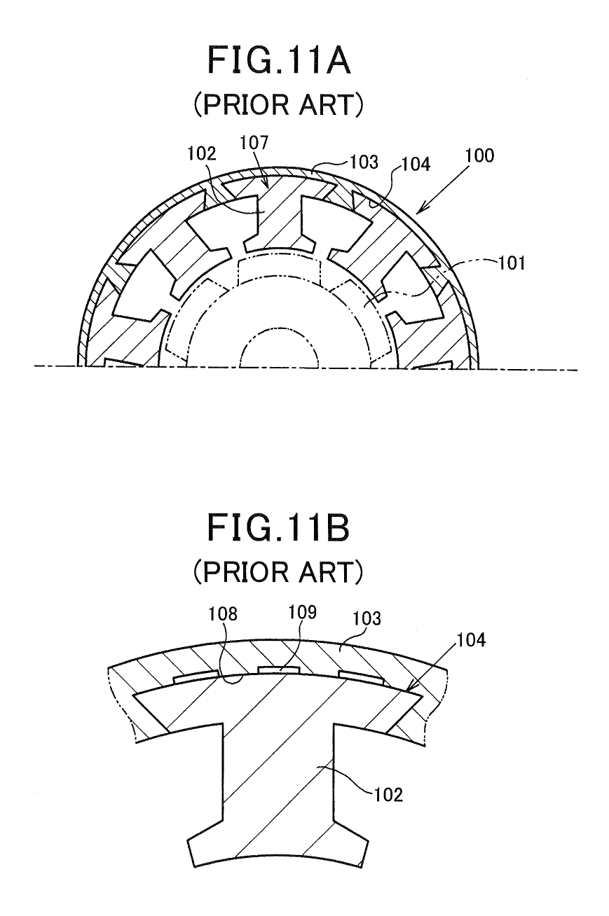

FIG. 9 illustrates the relationship between the ratio of the press-fitting interference g to the radially inward error δ and the angle a between each of the second contact surfaces 36 of the press-fit portion 22 and the centerline X of the tooth 10.

As seen from FIG. 9, the ratio g/δ decreases with the angle α. In other words, the smaller the angle α is, the less influence the radially inward error δ has on the press-fitting interference g. Therefore, it is preferable for the angle α to be less than 45°.

Accordingly, by specifying 0°<α<45°, it is possible to prevent the press-fitting interference from becoming too large or too small. Consequently, it is possible to secure a sufficient tooth-holding force of each of the joint portions 30 while preventing the press-fitting load from becoming too large.

Moreover, in the present embodiment, the dimensional relationship of W1<W2 is also specified.

Consequently, referring again to FIG. 4A, for each of the teeth 10, in that section of the magnetic flux path from the neck part 40 of the pressing-fitting portion 22 to the radially inner end 39 of the main body portion 23, the magnetic flux density at the neck part 40 is lower than that at the radially inner end 39.

Moreover, as shown in FIG. 5, the iron loss of the stator core 7 increases with the magnetic flux density as well as with the residual compressive stress.

Therefore, by lowering the magnetic flux density at the neck part 40 of the press-fit portion 22, where the residual compressive stress is generated, it is possible to suppress the iron loss of the stator core 7 from increasing.

In addition, the magnetic flux density at the radially inner end 39 of the main body portion 23 is higher than that at the neck part 40 of the press-fit portion 22. However, at the radially inner end 39, no residual compressive stress is generated. Therefore, it is still possible to suppress the iron loss of the stator core 7 from increasing.

Furthermore, in the present embodiment, the dimensional relationship of β1≦β2/2 is also specified.

Specifying the above dimensional relationship, it is possible to secure high performance of the electric rotating machine 1.

FIG. 10 illustrates both the relationship between the relative tooth-holding force of each of the joint portions 30 and the ratio β1/β2 and the relationship between the relative torque of the electric rotating machine 1 and the ratio β1/β2. Here, the relative tooth-holding force is the ratio of the actual tooth-holding force to a reference tooth-holding force that is achieved with β1/β2 being equal to 20%. Similarly, the relative torque is the ratio of the actual torque to a reference torque that is achieved with β1/β2 being equal to 20%.

As seen from FIG. 10, the torque of the electric rotating machine 1 decreases with increase in the ratio β1/β2. That is, as the depth β1 of the grooves 18 of the yoke 11 increases with the radial thickness β2 of the yoke 11 kept constant, the torque of the electric rotating machine 1 decreases.

As described above, in the present embodiment, the teeth 10 are separately formed from the yoke 11 and assembled to the yoke 11 by press-fitting the press-fit portions 22 thereof into the corresponding grooves 18 of the yoke 11. Consequently, the magnetic flux flowing in the yoke 11 may be influenced by the boundary surfaces between the teeth 10 and the yoke 11, deteriorating the magnetic characteristics of the stator 2 and thereby decreasing the torque of the electric rotating machine 1. Moreover, the lager the boundary surfaces, the more influence the magnetic flux flowing in the yoke 11 receives from the boundary surfaces.

Therefore, by setting the ratio β1/β2 small, in other words, by setting the depth β1 of the grooves 18 small with respect to the radial thickness β2 of the yoke 11, it is possible to keep the torque of the electric rotating machine 1 from being decreased.

In view of the above, in the present embodiment, the ratio β1/β2 is specified to be less than or equal to 50% (i.e., β1≦β2/2). Consequently, it is possible to secure a sufficient amount of magnetic flux flowing in the yoke 11, thereby ensuring high performance of the electric rotating machine 1.

Moreover, by setting the depth β1 of the grooves 18 small, it is possible to reduce the second contact surfaces 36 of the press-fit portions 22 of the teeth 10, thereby lowering the press-fitting load for press-fitting the press-fit portions 22 into the corresponding grooves 18 of the yoke 11. In addition, the range within which the residual compressive stress is generated can also be reduced, thereby decreasing the iron loss of the stator core 7.

On the other hand, in terms of securing a sufficient tooth-holding force of each of the joint portions 30, it is preferable for the ratio β1/β2 to be greater than or equal to 20%.

More specifically, as shown in FIG. 10, as the ratio β1/β2 increases from 20% to 50%, the torque of the electric rotating machine 1 is decreased by about 10%. Moreover, when the ratio β1/β2 is higher than 50%, the relative tooth-holding force exceeds 1.5, i.e., the tooth-holding force of each of the joint portions 30 is excessively large.

Accordingly, in terms of securing both a sufficient tooth-holding force of each of the joint portions 30 and high torque of the electric rotating machine 1, it is preferable that 0.2≦β1/β2≦0.5.

While the above particular embodiment has been shown and described, it will be understood by those skilled in the art that various modifications, changes, and improvements may be made without departing from the spirit of the invention.

For example, in the previous embodiment, the electric rotating machine 1 is configured as a three-phase AC motor. However, the electric rotating machine 1 may also be configured as, for example, a three-phase AC generator. In addition, in this case, the performance of the electric rotating machine 1 could be represented by the output AC power thereof.

Moreover, in the previous embodiment, the motor (i.e., the electric rotating machine 1) is an inner rotor-type motor in which the rotor 3 is rotatably disposed radially inside of the stator 2. However, the invention may also be applied to an outer rotor-type motor in which the rotor is rotatably disposed radially outside of the stator.

Furthermore, in the previous embodiment, the stator core 7 is configured to satisfy all of the dimensional relationships (1)-(5). However, the stator core 7 may also be configured to satisfy only the dimensional relationship (1) and part of the other dimensional relationships (2)-(5).

What is claimed is:

1. A stator for an electric rotating machine, the stator comprising:
a stator core; and
a multi-phase stator coil distributedly wound on the stator core,
wherein
the stator core includes a plurality of teeth and a yoke that is separately formed from the teeth and magnetically connects the teeth,
the yoke has a plurality of grooves formed in a surface thereof,
each of the teeth has a press-fit portion, which is press-fitted in a corresponding one of the grooves of the yoke, and a main body portion that extends from the press-fit portion in a direction away from the corresponding groove,
the press-fit portion has a pair of contact surfaces which are both in contact with a bottom surface of the corresponding groove of the yoke and away from each other in a width direction of the tooth, and
the following dimensional relationship is satisfied:
(a+b)≦e/2,
where a and b respectively represent widths of the contact surfaces of the press-fit portion, and e represents a width of the main body portion at a press-fit portion-side end of the main body portion.

2. The stator as set forth in claim 1, wherein the following dimensional relationship is further satisfied: a=b.

3. The stator as set forth in claim 1, wherein for each of the teeth of the stator core, the following dimensional relationship is further satisfied:
0.8≦d/e≦1.2,
where d represents a width of the press-fit portion at its end facing the bottom surface of the corresponding groove of the yoke.

4. The stator as set forth in claim 1, wherein for each of the teeth of the stator core, the contact surfaces are first contact surfaces of the press-fit portion,
the press-fit portion also has a pair of second contact surfaces which are respectively in contact with an opposite pair of side surfaces of the corresponding groove of the yoke, and the following dimensional relationship is further satisfied:
0°<α<45°,
where α represents an angle between each of the second contact surfaces and a centerline of the tooth, the centerline being an imaginary line which bisects the tooth in the width direction thereof.

5. The stator as set forth in claim 1, wherein each of the grooves of the yoke has a neck part in the vicinity of an open end of the groove which opens on the surface of the yoke, and
for each of the teeth of the stator core, the press-fit portion of the tooth has a neck part that is press-fitted to the neck part of the corresponding groove of the yoke, and
wherein
for each of the teeth of the stator core, the following dimensional relationship is further satisfied:
W1<W2,
where W1 represents a width of the main body portion at its end on the opposite side to the press-fit portion, and W2 represents a width of the press-fit portion at its neck part.

6. The stator as set forth in claim 1, wherein the following dimensional relationship is further satisfied:
β1≦β2/2,
where β1 represents a depth of each of the grooves of the yoke, and β2 is a radial thickness of the yoke.
